(19) United States
(12) Patent Application Publication
(10) Pub. No.: US 2007/0288644 A1
(43) Pub. Date: Dec. 13, 2007

(54) Systems and methods for developing and running applications in a web-based computing environment

(76) Inventors: Cesar Augusto Rojas, Mount Prospect, IL (US); Humberto Fandino, Glenview, IL (US)

Correspondence Address: Cesar Rojas;#207, 2348 S. Cannon Dr., Mount Prospect, IL, 60056, US

(21) Appl. No.: 11/448,214

(22) Filed: Jun. 7, 2006

(51) Int. Cl. G06F 15/16

(52) U.S. Cl. 709/230; 709/203

(57) ABSTRACT

Systems and methods for developing computer applications in a computer network environment by describing graphic user interface components and other application's components with a new XML markup language, by coding the component's behavior with an scripting programming language, and by deploying said applications to a client workstation running in a browser that contains a new virtual machine that replaces the HTML interpreter with an interpreter of the new markup language. The new virtual machine receives the application split in small modules, parses the XML descriptions and the scripting code and creates instances of the components to build the application on the client workstation. All the components are held by the new virtual machine, so that no new request to the server are made when the components are reused, minimizing the network traffic.

### CROSS REFERENCE TO RELATED APPLICATIONS

This application Claims benefit of U.S. Provisional Patent Application Ser. No. 60/468,195, filed on May 5, 2003 and entitled METHODS AND SYSTEMS TO DEVELOP AND EXECUTE APPLICATIONS ON THE INTERNET which is commonly assigned and the contents of which are expressly incorporated herein by reference.

### FEDERALLY SPONSORED RESEARCH

Not applicable

### SEQUENCE LISTING OR PROGRAM

Not applicable

### BACKGROUND OF THE INVENTION

1. Field of Invention

The present invention relates to the field of the development and execution of computer applications in a hypermedia distributed computer network environment using a new markup language (HPML) in combination with scripting languages and replacing the HTML render with a new software machine called Hyper Processor Machine (HPM)

2. Prior Art

A general discussion of the main aspects about current Internet programming techniques is necessary to understand why the present invention represents an important innovation that fills an existing void.

Currently there are four different ways to execute applications on LAN/WAN networks, as described subsequently:

(a) Heavy client applications installed on the client. These applications are developed with any programming language such as C/C++, Java, Visual Basic, etc. They allow the communication between client and server in such a way that clients can send data or request to the server and receive appropriate answer for the program execution. This type of programs must be installed on each computer where their execution is required. One of their main advantages is the use of rich user interfaces. In addition, as these programs are installed on the client computer, they are very fast and have excellent performance. Client programs are generally complex and huge, that is why they have been called heavy clients. When changes or updates are made to the application, it is necessary to reinstall the whole application or the modules affected by these changes on each client computer where the application was previously installed. On the other hand, these client programs have a very low security level because they have access to the operating system and to the client's hardware resources. Consequently, it is recommendable to install client programs only when they come from a well-known and secure source.

(b) Light applications installed on the server. Using a web browser installed on the client, the user can visualize the program using a textual description language (usually Hyper Text Markup Language, HTML), which is renderized on the screen each time the client interacts with the program (description). As these applications are not installed on each client, it is not necessary to reinstall them each time the application changes. HTML was not developed to execute applications, but to display and interchange information and documents, and more recently to share graphics, images, sound, videos, etc. Therefore, the development of rich and complex applications similar to heavy programs is practically impossible. However, in spite of its limitations, it is feasible to create applications with some restrictions using forms, which are apparently dynamic. Improvements to this type of application are reached embedding Activex or Java beans, but these components reduce the security level.

One of the main advantages of this programming technique, when no Activex components or binary code are embedded, is the high security level because the code does not interact with the client computer resources or the operating system. On the other hand, since the HTML applications move code frequently between server and client, the response time may become slow and consequently the performance of the application is generally poor in comparison to heavy applications (the speed depends on the bandwidth of the internet connection, the latency and the server response time)

Lately, many programmers are using a JavaScript and XML combination called AJAX to change specific areas of a web page to avoid the complete rendering of that page. However, this is a partial solution because when it is necessary to change the whole view, everything built with AJAX is lost, and the browser loads a new page destroying and deleting completely the previous page.

(c) Applications that stream executable program modules or modules in object code from the server to the client. This is a combination of the two methods described above. A heavy client application is divided in small modules, which are loaded and executed on demand. This technique may assembly rich and friendly client applications and they do not require previous installation on the client computer. Likewise, when changes or updates are made to the code, the application does not require installation. However, this technique presents problems associated with speed and security because pieces of object code (usually large and heavy) must be transmitted trough the net with access to the client computer resources and the operating system. Mostly, they are used in local area networks. Examples of this kind of programming technique are those developed by AppStream Inc. and Endeavors Technology, Inc.

(d) Rich client applications that use XML language in combination with JavaScript. A predefined set of graphic user interface objects created with JavaScript language is instantiated using an XML language to build the graphic user interface. Rich client applications are created with this technique and good security levels are achieved since no access to the operating system and user resources are allowed. However, the time response is poor because the graphic user interface objects have to be created in JavaScript each time the application is executed. Example of this kind of application is WebFace invented by Bruce K Grant.

There have been numerous attempts using this technology to develop rich applications. Some of these attempts use JavaScript to create graphic components such as buttons, edit boxes, combo boxes, check buttons, etc, to create the graphic user interface. Companies such as SCO (WebFace), Asperon and others are using this technique to create applications; however the results are slow applications with limited user interfaces given that the applications are embedded in a web page.

In order to develop optimum applications to be executed on the Internet the following features must be considered:

(a) The user interface must be complex, rich, and friendly similar to those of heavy clients.

(b) No initial installation on clients must be required.

(c) Updates and changes to the application must not require updates on each client computer.

(d) Security must be one of the main concerns; therefore, no binary code shall be sent from the server to the client.

(e) The application must be fast.

(f) Multiple hardware and software platforms must be supported by the application.

As discussed above, each one of the current existing Internet Programming techniques has some of the desirable characteristics, but they lack some of the others. In summary, there is not a complete solution that satisfies completely the requirements for an optimum Internet application performance. Large software companies are focused on improving the server infrastructure and the information processing between them. For clients, HTML has been adopted as standard to display Internet applications. HTML could be generated from a sequence of processes that could begin in a database, transformed into XML, manipulated by Cascading Style Sheets (CSS) and finally processed by the browser to render a page on the client. It appears that the Internet technology community has adopted this technique as something already defined and completely finished. ASP.NET, the last Microsoft technology for Internet programming, uses a mechanism to generate web forms that communicate with users by using XML, SOAP and UDDI, but finally said technology renders traditional HTML. The new Microsoft Internet programming technique represents important improvements with respect to its previous technology, but if observed in perspective, the essence of the ASP.NET has not changed: HTML renderized on the client, which do not represent a real change for developing True Internet Applications.

### SUMMARY OF THE INVENTION

This invention consists of a web processor software (HPM) that interprets Hyperprogram Markup Language (HPML), a new language developed to run applications on the web.

Unlike traditional web programming techniques, HPM does not process HTML pages and, therefore, it does not render the screen each time the user requests an action. Instead, HPM interacts with the application server using HPML—a new XML based language—and traditional scripting languages such as JavaScript, VBScript, etc.

The most important features of HPM are as follows:

(a) Given that it is not based on HTML pages, but on optimized objects assembled directly on the user workstation, HPM dramatically improves the web applications performance.

(b) Given that it does not process binary code but small XML descriptions, HPM is highly secure.

(c) Like desktop applications, HPM can execute complex and highly interactive applications including graphics, grids, trees, menus, toolbars, and many other graphic user interface components.

HPM is a Virtual Machine that reads and interprets instructions written in HPML language. HPM is a new interpreter that replaces the HTML interpreter in Internet Explorer (MSHTML.DLL). Using this new model, Internet Explorer loads the interpreter based on the document to be interpreted: MSHTML.DLL for HTML documents or STHPML.DLL for HPML web applications.

HPM uses a browser to render applications (the current version only uses Internet Explorer 5.0 or later). When the user wants to run an HPML application, he/she types the web address where the application is located and the application's name with the extension hpm or hpml. When the browser reads the extension, it identifies that the HPM machine needs to be loaded instead of the web browser render machine. At this moment, HPM starts showing the initial interface and assembles the different parts of the application, as they are required by the user.

Once HPM is loaded, it is placed between the browser and the operating system. HPM uses the Browser's frame to display the user interface, and the operating system to load the application and to check the security protocol. Additionally, HPM has a set of interface objects such as trees, grids, menus, toolbar, etc., included in the HPMLFramework. HPML applications use these objects to display the required interface or to communicate with the server through WebServices.

The HPML language is similar to the HTML language. HPML is based on the Extensible Markup Language (XML) to describe objects, and on scripting languages to control the behavior and the events fired for those objects. HPML is a client oriented language. It has been designed to move fast and easily from the server to the client, as well as to run securely on the client computer. An HPML program is made of several modules split in different files and distributed in one or more servers. Of all the modules, the main module serves as the starting point of the application. An HPML application is considered a whole module regardless of how many modules it was divided into.

The main task of HPM on the client workstation consists of assembling the application by using the modules implemented on one or more servers. When the user of a web application wants to start running it, he/she types the URL address of the application in the browser's address bar and HPM loads the starting module, keeping the other modules of the application untouched. This way, HPM builds the initial graphic interface. When the user uses a function that is part of a module, HPM searches for the module on the client workstation. If the module has not yet been loaded and assembled into the application, HPM loads the module from the server, checks the security protocol and calls the required function. If the module has been already loaded, HPM calls the function immediately. This way, as the user utilizes different options and functionalities of the application, more modules are gradually loaded, improving the application performance.

Data and information exchange between client and server is accomplished through different objects defined in the HPMLFramework—installed in the client workstation—. The HPMLFramework contains a rich set of objects for this purpose. Programmers can use these objects for information exchange by calling the WebMethods installed on the server.

### BRIEF DESCRIPTION OF THE DRAWINGS

FIG. 1 is a schematic illustration of the main parts of an Internet browser. It shows the main frame, the main menu, the toolbar(s), the address bar and the status bar of Microsoft Internet Explorer.

FIG. 2 is a schematic illustration that shows the sequence of events followed when a graphic component is required by the application to build a graphic user interface.

FIG. 3 shows the new logical relation between the operating system (OS), the HTML renderer (MSHTML.DLL), the HPML interpreter (STHPML.DLL), and the browser.

FIG. 4 shows the logical relation between the operating system (OS), the HPM, the HPMLFramework, and the browser.

FIG. 5 is a schematic illustration of the processes involved in the instantiation of an object in an HPML application.

FIG. 6 is an example of a graphic user interface generated by an HPML application.

FIG. 7 is an example of a complex graphic user interface generated by an HPML application.

FIG. 8 is an example of a complex graphic user interface generated by an HPML application.

### DETAILED DESCRIPTION OF THE INVENTION

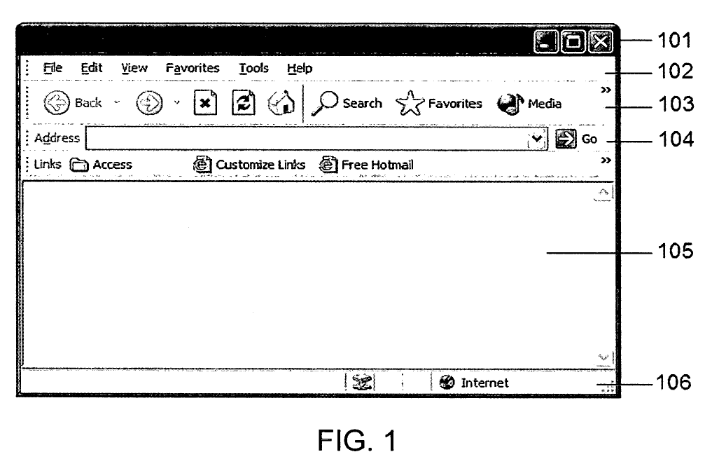

The present invention includes methods and systems for developing and running applications on a web based computer environment without renovating the current infrastructure of communications and servers and modifying only the client programming technique, taking advantage of the existing languages and software technologies. Currently, the main tool of the client's side is the browser, which renderizes HTML documents coming from the server and displays them on an area named the client area. The browser can be divided into six different parts as shown in FIG. 1

The main frame 101 is the container of all the objects of the Graphic User Interface (GUI). Main objects contained in the frame are: the main menu 102, which includes all the necessary options to navigate on the web; one or more toolbars 103 for quickly and frequently used actions; one address bar 104 to get access to web sites; and one status bar 106 that shows the status of the current process. In addition to the client area 105 where the information and pages are shown, commercial browsers (Internet Explorer, Netscape Navigator, Firefox and others) have additional features such as mail management, news groups, etc.

Traditional heavy client applications have basically the same configuration shown in FIG. 1: the main menu, one or more toolbars, and the status bar. The only difference with respect to the browser is that they do not have an address bar and the client area is customized in accordance with the application characteristics.

Consider the main frame as the base where the application will be developed. It is only necessary to remove the current object from the client area 105 and leave the address bar as an additional component to the traditional clients. Allow the objects of the main frame to be customized in accordance with the requirements of the new application. Permit changing or adding new options to the main menu, update the elements to the tool bar, modifying the components of the status bar, keeping the address bar to allow navigation between pages or between applications and, finally incorporating new customizable elements (objects) on the client area, in accordance with the requirements of the application.

Traditional applications have a set of GUI objects or controls organized in a logical manner according to the application requirements. Some of these controls are: buttons, check boxes, list boxes, combo boxes, radio buttons, etc. In addition, the GUI includes containers, which are objects capable of holding other objects such as forms, splits, frames, views, tool bars, status bars, etc. Other more complex set of objects can be included in an application such as calendars, charts, grids, text editors, draw controls, and other objects created by third part developers. The union of the above elements results in a complex interaction systems that enrich the GUI and make applications friendlier and more powerful

In other respect, GUI's objects have a series of attributes that allow them to exhibit different appearance like background color, text color, font type, and font size, among others. In general, all of the GUI's objects have common and particular attributes. Each GUI's object also has a set of methods that allow the objects to communicate with the external world and vice versa and to interact with other objects. In addition, the GUI's objects have a series of events that are triggered by user actions or by object requests. All this group of properties, methods and events, and the way that objects are displayed on the screen is known as the Model View Control (MVC). All this means that each object of the GUI can be described by using a simple model. The instances of the GUI's objects do not require being transported through the network. As they exist on the client computer, only a description of how the objects must be displayed on the screen it is necessary. But this description that is moved on the web must be secure. That is, no binary code must be used, but a textual description of how the objects must be shown on the client. The standard Extensible Markup Language, XML is the appropriate tool for this purpose. To better understand the suggested programming technique, the following example will be discussed: the client has an object button, which can be used to represent a button on a GUI. The textual description about how the button must be exhibited on a GUI resides on the server in XML format.

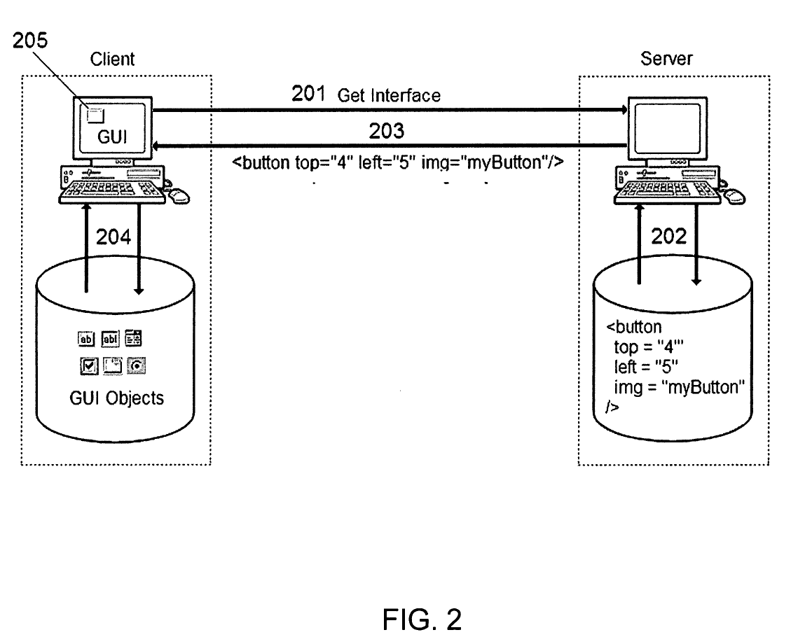

Initially, the client requests the server a description of the graphic interface 201 (FIG. 2). Once the server receives the request, it searches the required description in the database 202, and sends this description in XML to the client 203. Next, the client receives the description of the graphic interface, searches it in the database and instantiates the object in accordance with the description 204. When the object is instantiated and configured according to the properties, it is finally shown on the client 205. In summary, an object description is an XML textual representation that moves trough the net (WAN/LAN). When this description reaches the client computer, it is interpreted by HPM, which creates an instance of the object in accordance with that representation. Once the object is instantiated, it communicates with the external world (application) through messages and events. In a secure environment no binary code must be used to describe the events. Therefore, the most appropriate is to use scripting languages to describe the reactions to events. Scripting languages are very simple and convenient to develop client applications. They are relatively secure and their execution can be very fast once they reach the client and are verified and compiled. Thereby, a GUI's object can be described by its XML description, plus a set of methods written in a scripting language (VBScript, JScript, etc) that controls the actions of the recently created object.

Standalone applications (heavy clients) have an excellent performance because all the necessary code is installed on the client workstation. When the program is executed, the computer loads the program in memory and starts the execution. On the contrary, the Internet applications based on HTML are generally slow because they have to assemble and send the pages several times to the client, spending a lot of time renderizing them on the browser. In addition, the performance of web applications is critical when they run on clients with dial up connections. In order to achieve the best balance between security and performance, our invention uses the best of both worlds and allows the development and execution of secure applications, with rich and friendly GUI and excellent response time.

This new technology uses the method of traditional computing (standalone applications) along with the new model of light applications that utilize HTML. The client only requires a browser (Internet Explorer, Netscape Navigator, Firefox, etc.) to provide an initial frame with a client area to be used for the application. The address bar allows the user to invoke web pages and to navigate on the net or to run HPML applications. A page (HTML) is a web page including a form; and a program (description) is an application created with HPML language. The initial state is the state when the browser shows the default page or when the client area is empty. Likewise heavy client programs, when the user requires the execution of an application, he/she writes the Internet address and the program name in the address bar. The program is a set of XML descriptions and scripting code located on the server workstation(s) and sent to the client trough the Web. Non-executable or binary code is sent to the client, but textual description of objects. When the program reaches the client browser, HPM takes the control and begins to assemble the program description. HPM creates object instances and compiles the scripts, previous security checkups generating binary code, which accumulates in a cache, where the program is gradually assembled.

To increase the speed, the application installed on the server or servers is split in modules. There is an initial module that configures the GUI and shows it as though the application were installed on the client's computer. When users work with traditional applications they usually use only few of the dozens or hundred of the available options. Thus, the main concern is not about the application size, which can be several kilobytes (or megabytes), but with the way the modules are designed and distributed on the net. When the initial main screen is displayed, the user is ready to interact with the application. The user executes actions using the main menu, pressing icons on the toolbar or by any other means. When the execution of a module of software is required, the system checks if this module is already assembled in the application. In case it exists, the system proceeds to execute the code; otherwise, it downloads the program from the server, checks up the security of the code, instantiates the objects, compiles the code and, finally, assemblies the new module with the rest of the application. Next time, when this code module is executed, it will be more efficient because is kept in the cache.

Data and its presentation do not move together trough the net as occur with HTML. A characteristic of HPM is that it creates a work environment before it starts to work with data. Even though the possibility to mix data and presentation in the same program is possible, it is not recommended and must be avoided in order to get clarity and efficiency. In this invention, the program is coded in XML and the event reactions are written in scripting languages. Just like HTML, programmers have the possibility of using any scripting language (VBScript, JScript, Perl, etc.).

Programs can be split in multiple files in the server workstation(s) and each file must content a complete program module. For instance, if a process that loads a document to the active program is required, the program module must have a user interface, scripting code to control the object actions, and methods to process the document, once it is loaded on memory. In consequence, a complete program module can be defined as a portion of an application that execute a complete action on a document, group of documents, or data to accomplish a desired task. On the contrary, an incomplete module is a portion of the application that cannot realize a complete action on a document, group of documents or data. It is possible that HPM loads a complete module and assemblies it on the current application, but it cannot be processed because it requires that other modules be previously loaded. In consequence, a dependant module is defined as a module that requires that other modules be previously assembled to the application. In turn, an independent module is a module that does not require that other modules be previously assembled to the application. On the other hand, HMP does not require that all the modules be located in a single server workstation. Rather, the modules can be distributed in different server workstations across the web based network environment. Unlike traditional system applications, where the object code has to be present to execute an application, the complete HPML application does not require to be assembled to begin the execution. Furthermore, it is possible that in a work session to assemble all the modules to complete a task is not required. One of the advantages of this technology is that new modules can be assembled at any time, based on user's requirements.

Most of the process are significantly complex and require the use of languages different from scripts, such as C/C++, Java, Visual Basic, FORTRAN, etc. The code generated by these languages is very large to be sent through the network and can place at risk the client resources. Therefore, these processes are executed on the server in response to requirements (data/events) and sent for the client to the program modules assembled on the server workstation(s). In order to do this, HPM uses from simple communications process based on HTTP protocol, to higher-level protocols such as XML-RPC, SOAP or RMI. Thus, a complete application can be defined just like the group of all program modules that can be assembled on the client plus the group of all the modules that reside and execute on the server. This way, the current invention can be seen as a combination of traditional standalone applications and web programming using HTML, but taking the best of both worlds. In consequence, a new terminology has been coined to define the new programming technology:

Hyper programming markup language: is a web programming technique based on the development and assembly of small modules of software distributed on a web based computer environment.

Hyper program markup language: is a computer program developed using the hyper programming technique to be executed on the web based computer environment.

Hyper processing: is a method of assembling and execution of hyper-programs.

These terms have been introduced to distinguish the our new technology from the traditional client/server processing methods where the client (heavy client) application is completely defined and installed on the client workstation and the portion of the server is totally defined and installed on the server workstation. Likewise, the new definitions help to differentiate our technology from the new client/server architecture based on HTML (light clients), which the GUI is based on web forms apparently dynamics, but without the capabilities and richness of heavy clients.

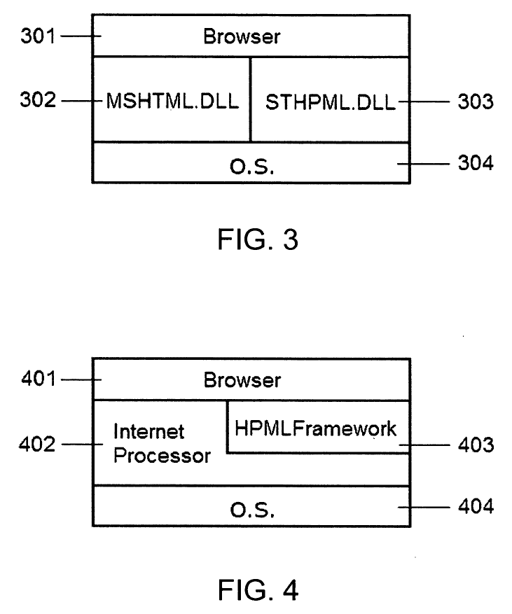

The main component of our invention, which must be installed on the client, has been denominated Hyper Processor Machine (HPM). HPM receives the program modules from the server, interprets them, instantiates the required objects, creates the correspondent object code, and finally assembles the new program modules into the application. Besides, HPM coordinates the execution of the application (process and events) and allows the communication with the modules located on the server, using different protocols (XML-RPC, SOAP, RMI, etc.) through HTTP. When the user runs a hyper program calling it from the address bar of the browser, HPM takes the control of the browser eliminating the object renderized by HTML and changing the frame (the main menu, the toolbars, the statusbar and the client area) to display different objects from those traditionally shown by Internet pages. HPM has been designed to execute not only on existing frames (Internet Explorer, Netscape, Firefox, etc), but it can be used to create a new frame from scratch. HPM reads and interprets instructions written in HPML language. The new interpreter completely replaces the HTML interpreter in Internet Explorer (MSHTML.DLL) as shown in FIG. 3. Using this new model, the browser 301 loads the interpreter based on the document to be interpreted: MSHTML.DLL 302 for HTML documents or STHPML.DLL 303 for web applications. Both interpreters in this approach are located between the browser and the operating system 304.

Once HPM is loaded (FIG. 4), it is placed between the browser 401 and the operating system 404. HPM 402 uses the Browser's frame to display the user interface, and the operating system to load the application and to check the security protocol. Additionally, HPM has a set of interface objects such as trees, grids, menus, toolbars, etc. included in the HPMLFramework 403. Applications written in HPML use these objects to display the required interface or to communicate with the server through WebServices.

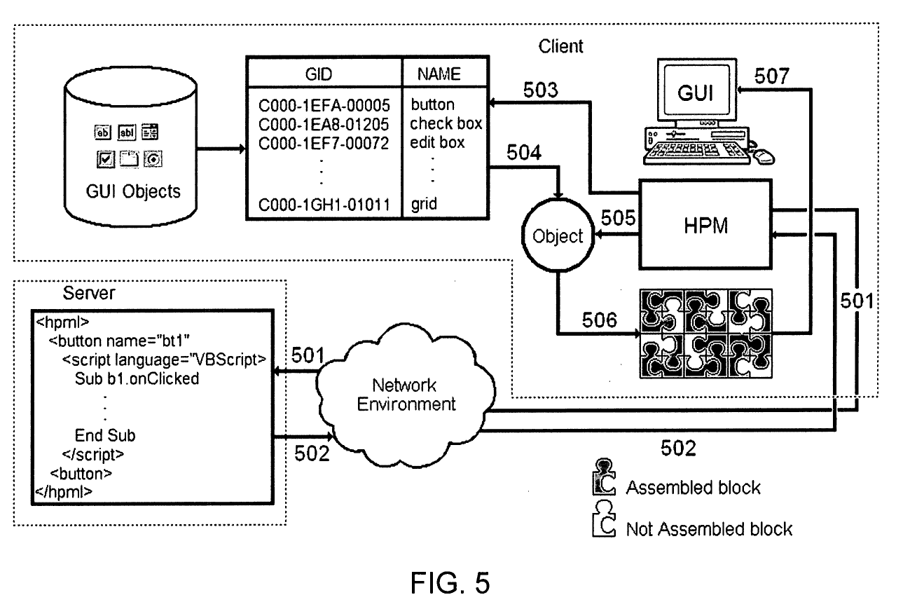

The way HPM works is described as follows: on the client side, there is a group of objects correspondent to each element of the GUI: edit box, button, combo box, list box, main menu, menu, menu item, etc. These objects can be dozens or hundreds, depending of the complexity of the GUI. They are configured in accordance with the program coming from the server. There is a database of the existing controls on the client; this is particularly important because new components can be gradually added to the client system. The database has a global unique identifier (GID) and a name for each component. This name is used when the program is received for the HPM, which uses it to search the GID in the database, creates an instance of the object, and configures it in accordance with the program. FIG. 5 illustrates the whole process.

The client or the client application requires a new program module 501. When the requirement is made for the first time, it goes directly to the server; subsequent requirements are managed by the HPM, which verifies if this module of code has already been loaded. If it is already loaded, is executed, otherwise, HPM send the requirement to the server trough HTTP.

The server looks for the required module of program and returns it to the client 502. In this case, it returns the module to the HPM.

HPM interprets the new requirement 503. In this example, a new GUI object “button” is required, so the HPM searches the name “button” in the database, obtains the GID and creates an instance of this object.

When the object is instantiated by the HPM 504, it does not know anything about the object. In fact, this must be the case in order to have independence between the HPM and the object. (It is important to notice that new objects can be added without modify the HPM). In addition, HPM checks and compiles any portion of the script, adding it to the application.

HPM transfer the correspondent portion of the specification to the object 505 in order that the object configures itself and instantiates and creates new children objects when necessary (composite objects).

The configured object is assembled in the application 506 and executed (if required) to display it on the GUI 507.

This process is repeated each time that the execution of an application module is required. Unlike hypertext, that specify format for documents, a hyper program specify format for programs with rich GUI. The program modules can be defined at execution time or they can be generated and assembled at invocation time, in accordance with particular characteristics of the application and user requests. The modules can proceed from different sources (server workstations), which allow that program modules coming from third-part developers be reused. A hyper program has the ability to communicate with applications on the server through Web Services, extending even more the hyper programming concept.

The hyper program is a global concept of an application made up of several program modules written with diverse languages, located on different servers around the world that can be executed on client computers at any time and place, without previous installation, providing high security level and rich GUI.

Just like HTML requires a web browser to be executed on the client, a hyper program needs a similar component on the client side. This component has been named Hyper Processor Machine (HPM), which assemblies and coordinates the execution of hyper programs proceeding from the server, as a result of client requests; so that, HPM is a processor program that supports multiple operating systems and hardware platforms. Each client that demands the execution of hyper programs requires previous installation of HPM.

A complete specification of hyper programming is too extensive to be included in this patent application. For a complete explanation of this concept refer to the articles mentioned in the section “Other References” of this patent.

The specification of a hyper process starts and ends with the tag <hpml> which stands for hyper process markup language:

<hpml>

.

.

.

</hpml>

As explained previously, the hyper program requires an initial specification for the frame, the main menu, the tool bars, and the status bar as well as for the initial client area. In consequence, the initial specification of a program would look like follows:

```
<hpml>
  <frame name = ‘mainframe’’>
    <menuBar name = ‘mainMenu’>
      <menu text = ‘File’>
```

| | |
|---|---|
| <menuItem name = ‘mnuNew’ | text = ‘New...’/> |
| <menuItem name = ‘mnuOpen’ | text = ‘Open Project...’/> |
| <menuItem name = ‘mnuSave’ | text = ‘Save’/> |
| <menuItem name = ‘mnuSaveAs’ | text = ‘Save As...’/> |
| <separator/> | |
| <menuItem name = ‘mnuPageSetup’ | text = ‘Page Setup...’/> |
| <menuItem name = ‘mnuPrint’ | text = ‘Print...’/> |
| <separator/> | |
| <menuItem name = ‘mnuExit’ | text = ‘Exit’/> |

```
      </menu>
    </menuBar>
    <script language = ‘javascript’>
      <!--
      function mnuExit_onClicked( )
      {
        frame.quit( );
      }
      -->
    </script>
    <toolBar name = ‘tb1’ allowsDocking = ‘TRUE’ border = ‘TRUE’>
          <button name = ‘btn1’ img = ‘image1.gif’/>
          <button name = ‘btn2’ img = ‘image2.gif’/>
          <separator/>
          <button name = ‘btn3’ text = ‘Button Text’/>
    </toolBar>
    <!-
      The following code is the specification of the
      initial component on the client area.
    -->
    <webBrowser name = ‘wbc’>
      <![CDATA[
        <html>
          <header>
            <title> Web Browser Component </title>
          </header>
          <body>
            Body Content
          </body>
        </html>
      ]]>
    </webBrowser>
  </frame>
</hpml>
```

The following comments are derived from the code above:

(a) The description is made in XML.

(b) The <frame> tag confines the initial configuration of the main menu, the toolbar and the status bar.

(c) The configuration of the main menu, toolbar and status bar is optional and it is empty for default. If the application is executed using a browser, these three components will remain unchanged.

(d) The actions (events) or functions can be defined by using any scripting language (JavaScript, VBScript, etc.) and placed in any part of the program.

(e) The client area can be configured in many ways using a rich set of components like splitters, panes, forms, docking windows, tables, text editors, trees, drawing controls, etc. In the example above, a webBrowser with an HTML page was inserted to show that HTML could be included as a subset of HPML. This feature makes a remarkable difference between our technology and traditional Internet programming: HTML is embedded into the application instead of the application being renderized by HTML.

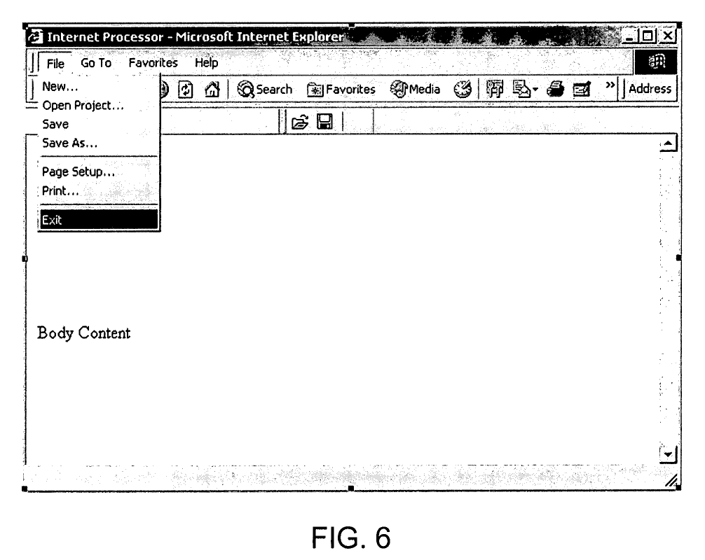

(f) When the hyper processor ends the interpretation of the HPML code, the user will have an application similar to a standalone application with a main menu, a toolbar, a status bar and a client area as, shown in FIGS. 6, 7 and 8.

(g) Given the way that HPML is specified, the applications present a high security level because they do not use binary code that interfere with storage devices, or client's operating system.

(h) For each tag included in the description: <mainMenu>, <menu>, <menuItem>, <separator>, <toolBar>, <button>, <webBrowser> and <frame>, must exist a correspondence with components installed on the client. These tags indicate to HPM that an instance of each one must be created, in accordance with the HPML specification.

(i) A program can be designed based on a tree structure with parent-child configuration. For instance, <mainMenu>, <toolBar> and <webBrowser> are <frame>'s children; <menu> is <mainMenu>'s child; <menuItem> and <separator> are <menu>'s children; and <button> and <separator> are <toolBar>'s children.

(j) A parent component is responsible for locating his children appropriately into the GUI. HPM delegates that responsibility to the first parent component, which locate his children adequately; in turn, it delegates to his children the responsibility to locate conveniently the grand children into the GUI, and so on. This way, the frame knows where locate the menu, the tool bar, the status bar, and the correspondent client area.

(k) Each component is identified with a unique name when it is created and this name may be used to refer to it during the whole process. As a standard, this name is defined with the attribute ‘name’ for each element of the specification.

(l) The initial specification of a hyper program must be contained between the tags <hpml></hpml> and <frame></frame> as shown in the example above. Other program modules do not require the <frame> tag:

```
<hpml>
    <form name = ‘myForm’ ...>
            .
            .
        child components
    </form>
</hpml>
or,
<hpml>
    <tree name = ‘myTree’ ...>
            .
            .
        tree information or
        tree components
    </tree>
    <list name = ‘myList’ ...>
            .
            .
        list information or
        list components
    </list>
</hpml>
```

A program specification does not only create GUI components. It can also specify components for client/server communication, for calls to server applications (web services), etc. The following example creates a web service component designated ‘ws1’, which allows the program to invoke functions of the application ‘myApp.asmx’ located on the server ‘svr1:

<webService name=‘ws1’ wsdl=http://svr1/myApp.asmx’/>

Actions on each component are created with any scripting language as shown in this example:

```
<hpml>
    <script language = ‘VBScript”>
        Sub B1_OnClicked
            MsgBox “B1 Clicked”/>
        End Sub
    </script>
</hpml>
```

The object named ‘B1’ is used to refer to the object into the scripting language. HPM reads the specification, creates the component with the name ‘B1’, compiles the script and assemblies it in the application. That way, the application is gradually assembled as the HPML modules are coming to the HPM. There are no restrictions in the way each program module is defined. It is responsibility of the programmer to optimize the modules in accordance with the characteristics of the application. However, the partitions must be defined considering bandwidth, latency and server time processing capacity, among others. In addition, our technology minimizes the communication client-server, allowing only data communication and no presentation plus data as HTML does. Our technology separates strictly application (server side), presentation (client side), and data.

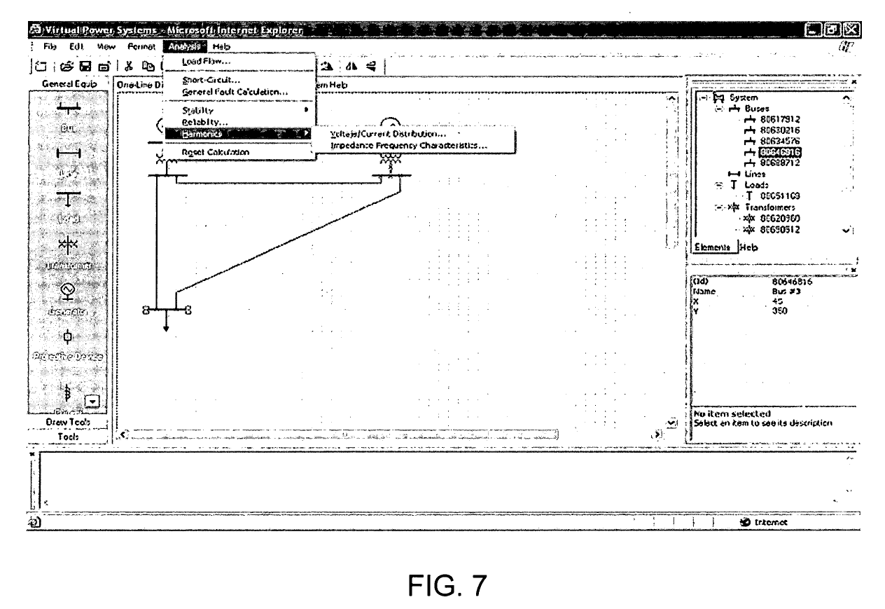

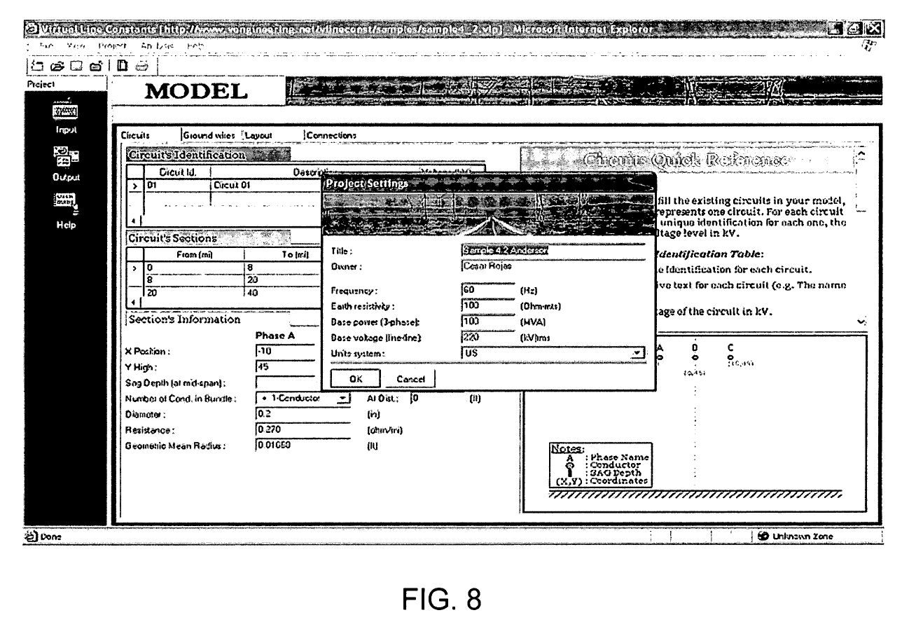

FIG. 7 and FIG. 8 show how complex a graphic user interface can be using HPML. They show how Internet Explorer is changed to allow an application with a complex GUI. The original main menu, toolbar, and view area were replaced by new ones.

In summary, our invention depicts a new software infrastructure to create and execute true applications through the Internet, matching the ideal requirements mentioned at the beginning of this document:

(a) A Graphic user interface highly dynamic and friendly

(b) Excellent response time

(c) No installation required

(d) No updates required on client

(e) High security levels

(f) Hardware and software multiplatform capability

Accordingly, systems and methods consistent with the present invention provide a new software infrastructure for building, deploying and processing secure, powerful, dynamic applications in a computer network environment by describing graphic user interface components and other application's components with a new XML markup language, by coding the component's behavior with an scripting programming language, and by deploying said applications to a client workstation running in a browser that contains a new virtual machine that replaces the HTML interpreter with an interpreter of the new markup language.

Other embodiments consistent with the invention will be apparent to those skilled in the art from consideration of the specification and practice of the embodiments disclosed herein. It is intended that the specification and examples be considered as exemplary only, with a true scope and spirit of the invention being indicated in the claims hereinafter appended.

What we claim as our invention is:

1. Computing system for running an application in a web-based computer environment, comprising:
a server workstation wherein said server workstation stores an application, wherein said application is divided in one or more modules, and wherein one of those modules is the main application module;
a client workstation wherein said client workstation comprises: a software machine called Hyper Processor Machine (HPM) and a web browser program such as Internet Explorer, Netscape Navigator or Firefox, and wherein said HPM replaces the current HTML render in a said web browser and said HPM first retrieves said main module, creating and storing instances of the objects described in said main module, wherein said main module has the ability to recover one or more application modules as required, and merging said modules and storing the total state of said application in said client workstation;
a network environment wherein said network environment is used to move said modules from said server workstation to a said client workstation; and
a new markup language called Hyper Program Markup Language (HPML), wherein said HPML language is used to describe said application modules and wherein said description is object oriented programming based.
Said application that resides in said server workstation is called HPML application.

2. The system of claim 1 wherein said HPML application that resides on said server workstation can be a static application.

3. The system of claim 1 wherein said HPML application that resides on said server workstation can be changed or created dynamically by a server application.

4. The system of claim 1 wherein said HPML application that resides on said server workstation is independent of the hardware and software installed on said server workstation.
The software installed on said server workstation includes the operation system and the web server. Said server workstation also can hold web services used by said HPML application.

5. The system of claim 1 wherein said HPML application modules can reside on different server workstation.

6. The system of claim 1 wherein said HPM residing in said client workstation is independent of the web browser
In addition, HPM is independent of the hardware and software installed on said client workstation.

7. The system of claim 6 wherein said HPM can be executed as a standalone application, without using any web browser.

8. The system of claim 1 wherein said HPM further retrieves one or more modules of said HPML application and executes said modules on said client workstation.

9. The system of claim 8 wherein said HPM can retrieve said one or more modules as required.
The result of merging and storing said modules on said client workstation is called the state of said HPML application.

10. The system of claim 1 wherein said HPM can change the appearance of said web browser for a new appearance specified by said HPML application.

11. The system of claim 1 further comprise a real-time, bi-directional messaging system for sending and receiving messages between said client workstation and said server workstation over said computer network environment.

12. The system of claim 11, wherein said computer network environment comprises the World Wide Web (Web).

13. The system of claim 11, wherein said computer network environment comprises a wireless network.

14. The system of claim 11, wherein said computer network environment comprises a local area network (LAN).

15. The system of claim 11, wherein said computer network environment comprises a loop back local communication.

16. The system of claim 1 wherein said HPML comprises an Extensible Markup Language (XML) format.

17. The system of claim 1 wherein said HPML uses the object oriented programming paradigm to describe HPML classes in said HPML application.

18. The system of claim 17 wherein said HPML language is used in combination with any scripting language to describe the behavior of said HPML class instances.

19. The system of claim 1 wherein said HPML uses a framework installed on said client workstation to create instances of the GUI of HPML classes.
Said framework is called HPML framework.

20. The system of claim 19 wherein said HPML Framework comprises: GUI components, GUI containers, system collections, and system objects.

21. The system of claim 1 wherein said application can use a Cascade Style Sheet (CSS) to change the appearance of said application.

22. The method for running an application in a web-based computer environment, comprising:
writing said application using said Hyper Program Markup Language (HPML);
storing said application statically in a server workstation or generating said application dynamically by a web-server application such as Internet Information Server (IIS), Apache, etc;
receiving said application by HPM, parsing said application by said HPM, creating the object instances described by said application, retaining the state of said application in the said client workstation and exposing those objects to the end-user, as required; and
moving said application from said server workstation to said client workstation using any network protocol such as HTTP, HTTPS, etc.

23. The method of claim 22 further comprising:
generating said application dynamically by a server Hyper Process Application Generator (HPAG) and transforming an HPML template application module into a new HPML application module.

24. The method of claim 22 further comprising:
sending and receiving messages between said client workstation and said server workstation over a network via a real-time bidirectional system.

25. The method of claim 24 wherein said messaging system can send and receive messages between said client workstation and said server workstation using any network protocol such as HTTP, HTTPS, etc.

26. The method of claim 22 wherein said network environment can be LAN, WAN or WiFi.

27. The method of claim 22 wherein said network environment uses any communication protocol such as TCP/IP, NetBEUI, and IPX/SPX, among others.

28. The method of claim 22 wherein said application, written with said HPML language, communicates with remote applications created with different programming languages such as C/C++, C#, Java, etc., residing in said network server or in different network severs within the same network environment or in different network environments, using SOAP protocol, XML-RPC, etc.

29. The method of claim 28 wherein said application uses Extensible Markup Language (XML) to interchange data between said client workstation and said network server(s) connected to said network environment(s).

30. The method of claim 22 further comprising:
retrieving a first HPML application module, creating the object instances specified by the HPML code and storing said object instances, wherein said object instances define a first state of said HPML application;
retrieving a second HPML application module, creating the object instances specified by the HPML code and storing said object instances; and
merging said first HPML application and said second HPML application module thereby forming a new state of said HPML application.

31. The method of claim 22 further comprising:
updating said new state of said HPML application by retrieving one or more additional HPML application modules, creating and storing one or more object instances, and merging said one or more additional object instances thereby forming an updated state of said HPML application.

32. The method of claim 22 wherein said HPML application consists of XML code representing classes and scripting language code representing actions on said classes.

33. The method of claim 22 wherein said HPML application state is maintained in a Document Object Model (DOM).

34. The method of claim 22 wherein said client workstation is selected from a group consisting of a desktop computer, a laptop computer, a handheld device or a smart phone.

35. The method of claim 22 further comprising one or more servers and said client workstation is adapted to retrieve any one of said HPML program modules from any of said one or more server workstations.

36. The method of claim 22 wherein said HPM runs within a web browser.

37. The method of claim 22 wherein said HPM runs outside a web browser.

38. The method of claim 22 wherein said HPM changes the interface of a web browser, wherein said interface comprises the main menu, the toolbar, the status bar and the main view area.
